(19) United States
(12) Patent Application Publication
(10) Pub. No.: US 2007/0205287 A1
(43) Pub. Date: Sep. 6, 2007

(54) OPTICAL SYSTEM FOR BARCODE SCANNER

(75) Inventor: Kai-Yuan Tien, Hsichih City (TW)

Correspondence Address: RIOTEC CO., LTD., P.O. BOX 108-00403, TAIPEI, omitted

(73) Assignee: RIOTEC CO., LTD., Taipei City (TW)

(21) Appl. No.: 11/423,955

(22) Filed: Jun. 14, 2006

(30) Foreign Application Priority Data
Mar. 1, 2006 (TW) 095203387

(51) Int. Cl. G06K 7/10; G06K 15/12

(52) U.S. Cl. 235/462.41; 235/462.42

(57) ABSTRACT

An optical system used in a barcode scanner is disclosed to include a light source for emitting a dot-shaped light beam in a slanting angle, a standing cylindrical lens for expanding the dot-shaped light beam produced by the light source as a line-shaped light beam onto a barcode of a product in a slanting angle, which line-shaped light beam showing a light intensity distribution curve that is asymmetric between the left side and the right side, a linear sensor array, and a focusing lens for focusing a reflective image of the barcode onto the linear sensor array. A reflector means can be provided for overlapping the light path to reduce the size of the barcode scanner. Further, a shaking means may be used to cause reciprocation of the light beam in direction perpendicular to the light path of the light source, thereby eliminating image noises due to existence of black holes.

This application claims the priority benefit of Taiwan patent application number 095203387 filed on Mar. 1, 2006.

### BACKGROUND OF THE INVENTION

1. Field of the Invention

The present invention relates to a barcode scanner and more particularly, to an optical system for barcode scanner, which uses a standing cylindrical lens to expand a dot-shaped light beam emitted by the light source as a line-shaped light beam such that the light intensity curve of the line-shaped light beam that falls to a barcode shows an asymmetric characteristics between the left side and the right side. The optical system lowers the manufacturing cost of the barcode scanner and reduces the size of the barcode scanner by means of overlap of light paths, and eliminates image noises due to the black holes in the light beam by means of the application of shaker means.

2. Description of the Related Art

Conventional barcode scanners commonly use a linear sensor array to receive reflective image from the barcode. The light beam on the barcode for the reflective image received by the linear sensor array is preferably in a uniform status to facilitate further barcode signal processing. FIG. 7 is a schematic top view showing the structure of a conventional barcode scanner. FIG. 8A is a schematic drawing showing the distribution of light intensity of the conventional barcode scanner. FIG. 8B is a schematic signal curve obtained from the barcode scanner according to the prior art. According to this design, the barcode scanner comprises two laser diode modules A1, two standing cylindrical lenses A2, a focusing lens A3 and a linear sensor array A4. Each laser diode module A1 is comprised of a laser diode and a collimator. The two laser diode modules A1 and the two standing cylindrical lenses A2 are respectively arranged at two sides relative to the focusing lens A3. The dot-shaped light beam emitted by each laser diode module A1 passes through the associating standing cylindrical lens A2, forming a overlapping line-shaped light beam that falls to a barcode A6. The line-shaped light beam that falls to the barcode A6 is then reflected by the barcode A6, and then focused by the focusing lens A3 onto the linear sensor array A4, enabling the linear sensor array A4 to receive an image of the barcode A6. According to this design, the light intensity distribution curve D₁ of the line-shaped light beam that passed from one of the laser diode modules A1 through the associating standing cylindrical lens A2 is a Gaussian curve; the light intensity distribution curve D₂ of the line-shaped light beam that passed from the other of the laser diode modules A1 through the associating standing cylindrical lens A2 is also a Gaussian curve; each light intensity distribution curve has only a short uniform region (for example, from B₁ to B₂). Therefore, when the light beams from the two laser diode modules A1 expanded through the associating standing cylindrical lenses A2 are overlapped, a uniform light intensity distribution curve D₃ is thus obtained. The plane image signal or barcode image signal on barcode plane that are received by the linear sensor array A4 are signal lines E₁ and E₂ respectively. When the image signal is obtained, it is compared to a zero-slope reference level line E₃ by a signal processing circuit for obtaining the desired barcode signal. However, because this design uses two laser diode modules A1 and two standing cylindrical lenses A2 to provide two projection light beams, the manufacturing cost of the barcode scanner is high. Further, because the light beams from the two laser diode modules A1 through the two standing cylindrical lenses A2 are on two different optical planes, the two optical planes must be overlapped to form a co-plane so that the desired uniform light intensity distribution curve D3 can be obtained. However, this limitation complicates the installation, and the yield rate after installation is low. One single laser diode module may be used with a beam splitter and a reflecting mirror and dual standing cylindrical lenses to substitute for the aforesaid dual laser diode module and dual standing cylindrical lenses design. However, this design encounters the same problem.

According to the design shown in FIG. 7, the focal distance of the focusing lens A3 is X1, and the length of the linear sensor array A4 is Y1. When designing the internal structure, a space must be reserved as light path space C1 (the hatched region). Because this light path space C1 must be kept clearance, it greatly increases the dimensions of the barcode scanner. FIGS. 9 and 10 show another prior art structure of barcode scanner adapted to eliminate the aforesaid drawback. According to this design, a reflecting mirror A5 is used to change the light path, thereby shortening the distance of the light path space in X-axis. However, because the focal distance of the focusing lens A3 is fixed, X2+X3 or X4+X5=X1. However, because the light path after reflection is independent, a different space must be provided for this independent light path. Therefore, this design shortens the distance in X-axis, however it requires a relatively greater space in Z-axis. Further, the reservation region (dotted region) C2 is normally used for designing illumination. However, the area of the reservation region C2 is small and is not enough to design illumination. Therefore, the light source structure is designed sideways from reservation region C2, thereby increasing the designed space and cost.

Therefore, it is desirable to provide an optical system for barcode scanner that eliminates the drawbacks of the aforesaid conventional designs.

### SUMMARY OF THE INVENTION

The present invention has been accomplished under the circumstances in view. According to one embodiment of the present invention, the optical system is used in a barcode scanner, comprising a light source adapted to emit a dot-shaped light beam onto a barcode of a product in a slanting angle, a standing cylindrical lens adapted to expand the dot-shaped light beam produced by the light source as a line-shaped light beam onto the barcode in a slanting angle, which expanded light beam showing a light intensity distribution curve that is asymmetric between the left side and the right side, a linear sensor array, and a focusing lens adapted to focus the image reflected by the barcode onto the linear sensor array. According to an alternate form of the present invention, the optical system comprises a light source adapted to emit a dot-shaped light beam onto a barcode of a product, a standing cylindrical lens adapted to expand the dot-shaped light beam produced by the light source as a line-shaped light beam onto the barcode in a slanting angle, a focusing lens adapted to focus the image reflected by the barcode that has different levels between the left side and the right side, a linear sensor array, and a reflector means mounted in the midway of the focal distance of the focusing lens and adapted to reflect the image onto the linear sensor array, wherein the light path of the reflector means is overlapped with the light path of the focusing lens to form a light path overlap region. According to another alternate form of the present invention, the optical system comprises a light source adapted to emit a dot-shaped light beam onto a barcode of a product, a standing cylindrical lens adapted to expand the dot-shaped light beam produced by the light source as a line-shaped light beam onto the barcode in a slanting angle, a focusing lens adapted to focus an image reflected by the barcode, a linear sensor array adapted to receive the image of the reflective light beam focused by the focusing lens, and shaking means adapted to cause reciprocation of the light beam in direction perpendicular to the light path of the light source.

### BRIEF DESCRIPTION OF THE DRAWINGS

FIG. 1 is a schematic top view of an optical system used in a barcode scanner in accordance with the present invention.

FIG. 2A is a schematic of light intensity curve obtained from the optical system according to the present invention.

FIG. 2B is a schematic of image signal intensity curve obtained from the linear sensor array of the optical system according to the present invention (I).

FIG. 3 is a schematic top view of an alternate form of the optical system according to the present invention.

FIG. 4 is a schematic side view of the optical system shown in FIG. 3.

FIG. 5 is a schematic of image signal intensity curve obtained from the linear sensor array of the optical system according to the present invention (II).

FIG. 6A is a schematic drawing showing another alternate form of the optical system according to the present invention (I).

FIG. 6B is a schematic drawing showing another alternate form of the optical system according to the present invention (II).

FIG. 6C is a schematic drawing showing another alternate form of the optical system according to the present invention (III).

FIG. 6D is a schematic drawing showing another alternate form of the optical system according to the present invention (IV).

FIG. 7 is a schematic top view showing the structure of a conventional barcode scanner.

FIG. 8A is a schematic drawing showing the distribution of light intensity of the conventional barcode scanner.

FIG. 8B is a schematic of image signal curve obtained from the barcode scanner according to the prior art.

FIG. 9 is a schematic side view showing another structure of barcode scanner according to the prior art (I).

FIG. 10 is a schematic side view showing another structure of barcode scanner according to the prior art (II).

### DETAILED DESCRIPTION OF THE PREFERRED EMBODIMENT

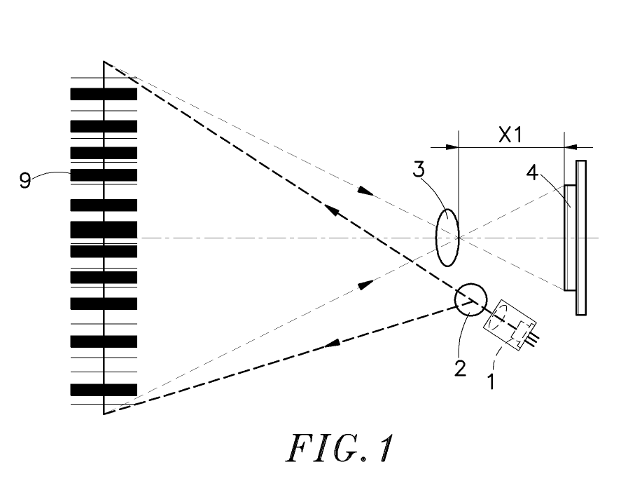

Referring to FIG. 1, an optical system in accordance with a first embodiment of the present invention is shown comprised of a light source 1, a standing cylindrical lens 2, a focusing lens 3, and a linear sensor array 4.

The light source 1 can be formed of a light emitting element and a collimator to provide a dot-shaped light beam of parallel light in a slanting angle relative to a plane of a barcode 9 of a product to be scanned.

The standing cylindrical lens 2 is adapted to expand the dot-shaped light beam produced by the light source 1 as a line-shaped light beam to project onto the barcode 9 of the product.

The focusing lens 3 is adapted to receive the barcode image reflected by the barcode 9 and to focus the barcode image. Further, the focal distance of the focusing lens 3 is X1.

The linear sensor array 4 is adapted to receive the image focused by the focusing lens 3, which image has different levels between the left side and the right side.

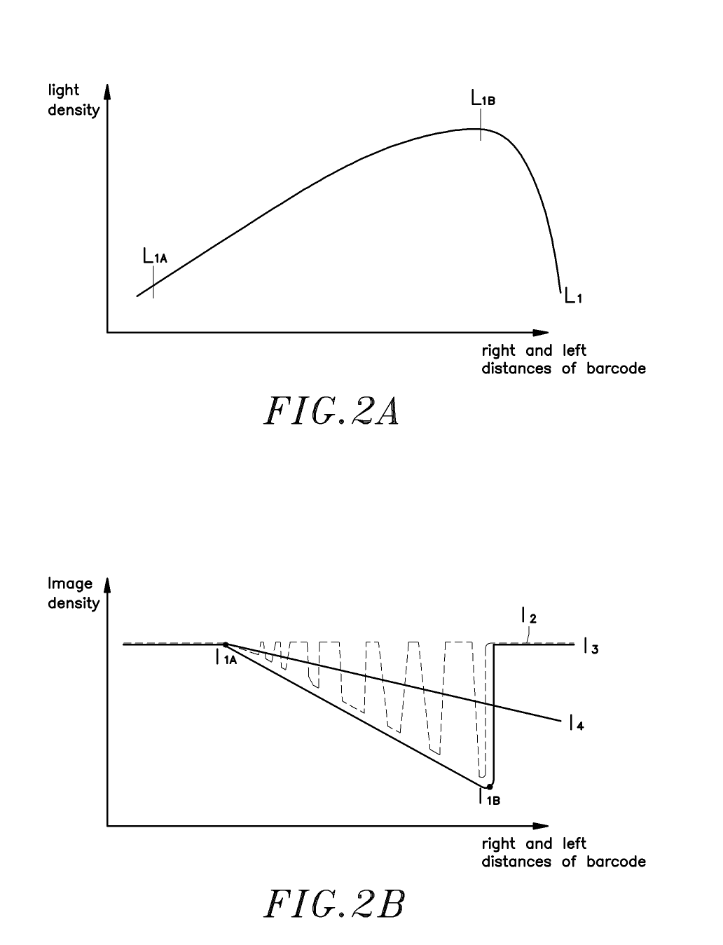

Referring to FIGS. 2A and 2B and FIG. 1 again, the light source 1 emits a dot-shaped light beam to the standing cylindrical lens 2, which enables a line-shaped light beam to be projected onto the barcode 9 of the product in a slanting angle relative to the plan of the barcode 9. The projected line-shaped light beam is then reflected by the barcode 9 to the focusing lens 3. After having been expanded by the standing cylindrical lens 2, the Gaussian curve L₁ of the light intensity thus obtained from the line-shaped light beam that is projected onto the barcode 9 is a deformation curve that is asymmetric between the left side and the right side. The segment of the light intensity between point L_{1A} and point L_{1B} of the deformation curve L₁ is fetched for reading the barcode 9, or in case the product of the barcode region is a white paper, the barcode reflective signal and the white paper reflective signal received by the linear sensor array 4 will be barcode image signal line I₂ and white paper image signal line I₃ respectively, and the image signal obtained by the linear sensor array 4 will be in contra to the light intensity, i.e., the stronger the light intensity is the deeper the image signal will be, or on the contrary, the image signal will be shallower if the light intensity is relatively weaker. The image signal is then determined subject to a variable level line I4 of which the slope≠0 and the variation of slope is not sharp. Thus, the reading of the barcode image signal is easily achieved.

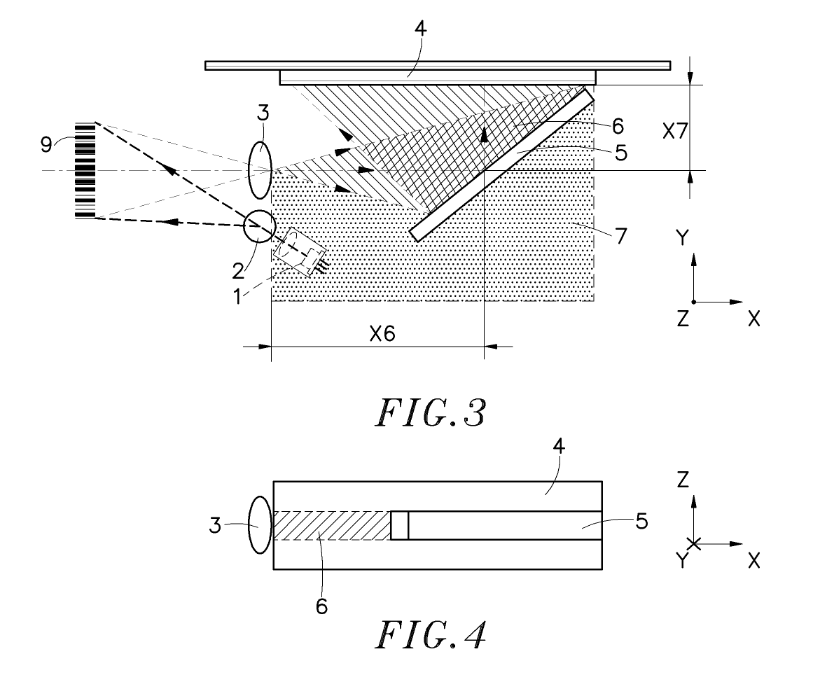

Referring to FIGS. 3 and 4, this second embodiment is substantially similar to the aforesaid first embodiment with the exception of the added reflector means 5. When the focusing lens 3 focuses the image reflected by the barcode 9, the reflector means 5 reflects the image of the barcode 9 onto the linear sensor array 4, wherein X6+X7=the focal distance X1 of the focusing lens 3. However, because the light path of the focus of the focusing lens 3 and the light path of the light beam reflected by the reflector means 5 are overlapped, both form a common light path overlap region 6 (the crosshatched region), and the reflector means 5 curves the light path and overlaps the light path onto the same plane, thereby saving occupied area on X-Y plane. The greater the overlap region 6 is the smaller the occupied area will be. This design does not increase space occupation on X-Z plane, and provides a complete space as a reservation 7 for the design of illumination light source. By means of utilizing the overlapping characteristic of light, the invention greatly reduces the size of the barcode scanner, eliminating the drawback of bulky size of the conventional designs. Further, the reflector means 5 can be comprised of at least one reflecting mirror.

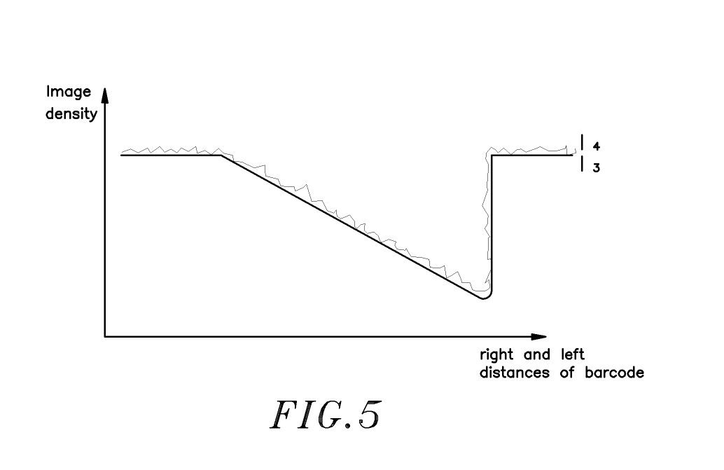

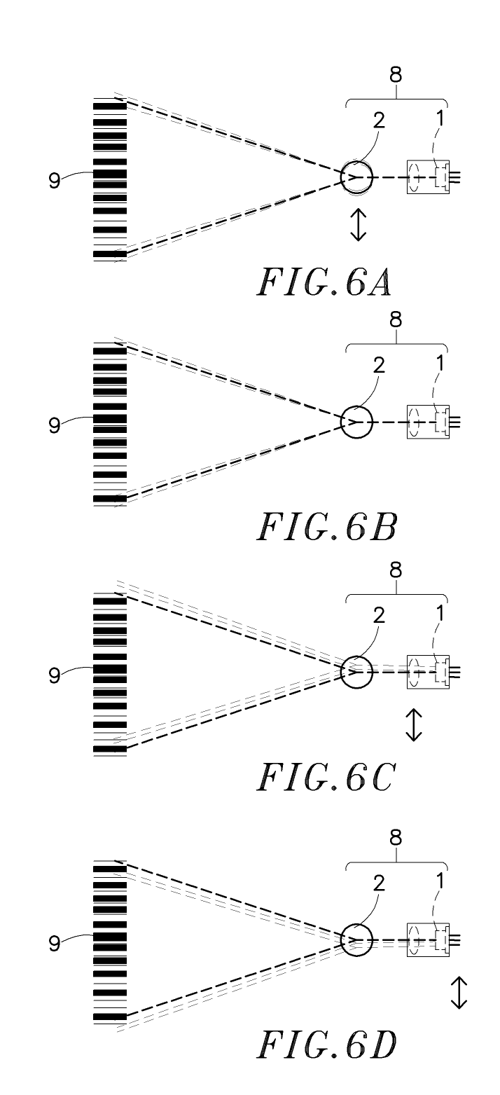

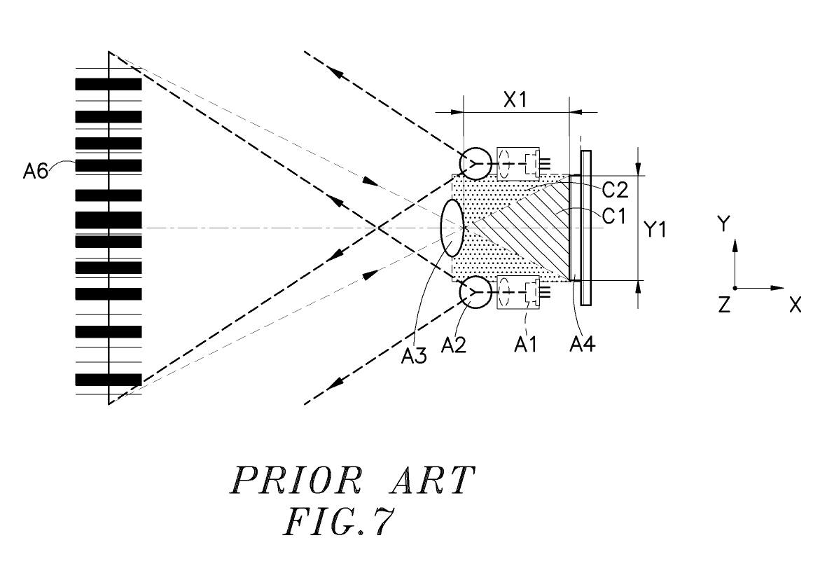

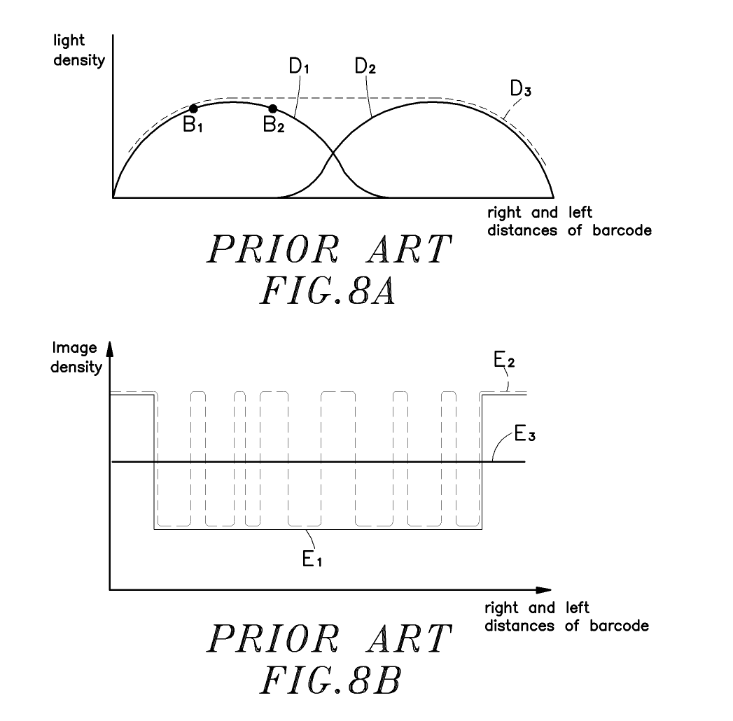

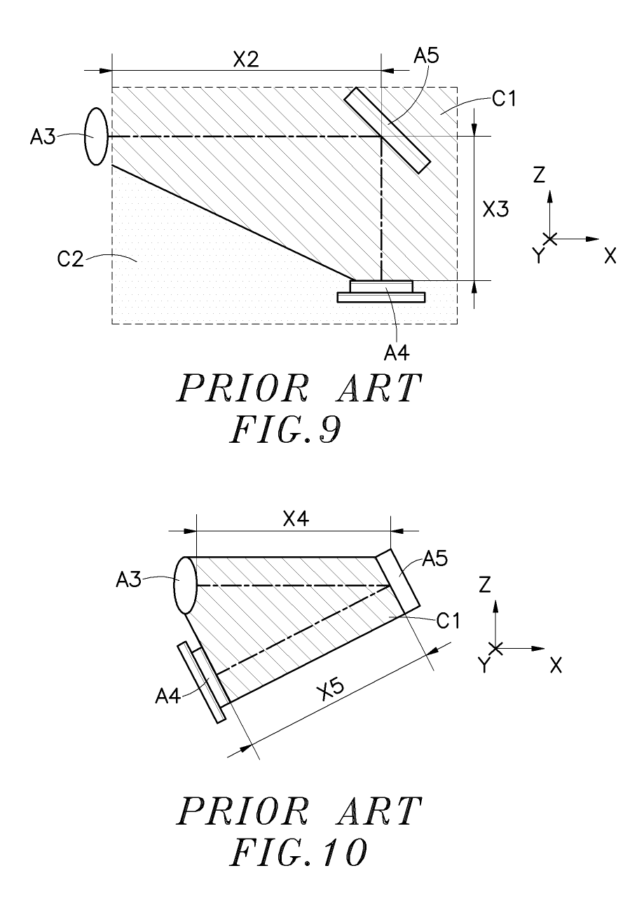

Referring to FIG. 5 and FIGS. 6A˜6D, if the light emitting element of the light source 1 is a laser diode, there will be many black hole regions without laser photons in the line-shaped laser light beam expanded by the standing cylindrical lens 2. When the line-shaped laser light beam is projected onto white paper through the standing cylindrical lens 2, the light image signal line received by the linear sensor array 4 is not the smooth light image signal line I₃ but the curved light image signal line I₄. Because the black holes form image noises, the image noises are not removable when reading a high-resolution barcode 9, thereby affecting the barcode 9 reading performance. In order to eliminate this problem, shaking means 8 is used in the optical system and adapted to cause reciprocation of the emitted light of the light source 1 within a small distance. The shaking means 8 can be a mechanical shaker made to reciprocate the standing cylindrical lens 2 within a very small distance in direction perpendicular to the light path. Alternatively, a voltage can be applied to the standing cylindrical lens 2 to cause the standing cylindrical lens 2 to change its crystal structure like the oscillation of a quartz oscillator so that the light beam is reciprocated within a small distance in direction perpendicular to the light path. Alternatively, the shaking means 8 can be made to reciprocate the proximity side or remote side of the light source 1 relative to the standing cylindrical lens 2 within a small distance in direction perpendicular to the light path so as to remove the black holes and to change the light image signal line from the curved light image signal line I₄ to the smooth light image signal line I₃. Therefore, the use of the shaking means 8 eliminates image noises, improving barcode 9 reading performance.

Further, the aforesaid shaking means 8 can be mechanical spring means that supports the standing cylindrical lens 2 and causes the standing cylindrical lens 2 to move alternatively back and forth within a small distance. Any of a variety of other measures to make relative motion between the light source 1 and the standing cylindrical lens 2 may be employed, achieving the same effect.

Further, the light emitting element of the light source 1 according to the present invention can be a laser diode or a light emitting diode that emits a dot-shaped light beam.

As stated above, the invention provides an optical system for use in a barcode scanner that has the following advantages:

1. The invention utilizes the light beam emitted by a light source and expanded by a standing cylindrical lens that has different intensity between the left side and the right side, and then focused through a focusing lens, so that the light image distribution curve thus obtained from the linear sensor array is a deformation curve that is asymmetric between the left side and the right side. Further, the invention utilizes a variable level line of which the slope≠0 to determine barcode signal. Therefore, the invention reduces the component parts of the barcode scanner and lowers the manufacturing cost, eliminating the drawback of high installation difficulty of the prior art design due to the formation of a common plane from overlap of different light planes.

2. The invention uses a focusing lens to focus the reflective image of the barcode and a reflector means in the midway of the focal distance to reflect image onto a linear sensor array, enabling the light path of the reflector to be overlapped with the light path of the focus of the focusing lens so that both the focusing lens and the reflector means produce a light path overlap region for common use to reduce the size of the barcode scanner.

3. The invention uses shaking means to cause reciprocation of the light beam emitted from the light source in direction perpendicular to the light path, so that a curved light image signal line can be changed to a smooth light image signal line, eliminating noises of black holes and improving the reading performance of the barcode scanner.

A prototype of optical system for barcode scanner has been constructed with the features of FIGS. 1˜6. The optical system for barcode scanner functions smoothly to provide all of the features discussed earlier.

Although particular embodiments of the invention have been described in detail for purposes of illustration, various modifications and enhancements may be made without departing from the spirit and scope of the invention.

What the invention claimed is:

1. An optical system used in a barcode scanner for reading a barcode of a product, the optical system comprising:
a light source adapted to emit a dot-shaped light beam onto the barcode of the product in a slanting angle;
a standing cylindrical lens adapted to expand the dot-shaped light beam produced by said light source as a line-shaped light beam onto the barcode of the product in a slanting angle, said expanded light beam showing a light intensity distribution curve that is a deformation curve that is asymmetric between the left side and the right side;
a focusing lens adapted to focus an image reflected by the barcode of the product; and
a linear sensor array adopted to receive the image focused by the focusing lens, wherein the reflective image has different levels between the left side and the right side.

2. The optical system as claimed in claim 1, wherein said light source is comprised of a laser diode and a collimator.

3. The optical system as claimed in claim 1, wherein said light source is comprised of a light emitting diode and a collimator.

4. The optical system as claimed in claim 1, which uses a variable level line having a slope not equal to zero as a reference line for image signal processing.

5. An optical system used in a barcode scanner for reading a barcode of a product, the optical system comprising:
a light source adapted to emit a dot-shaped light beam onto the barcode of the product;
a standing cylindrical lens adapted to expand the dot-shaped light beam produced by said light source as a line-shaped light beam onto the barcode of the product in a slanting angle;
a focusing lens adapted to focus an image reflected by the barcode of the product;
a linear sensor array; and
reflector means mounted in the midway of the focal distance of said focusing lens and adapted to reflect said image onto said linear sensor array, the light path of said reflector means being overlapped with the light path of said focusing lens to form a light path overlap region.

6. The optical system as claimed in claim 5, wherein said light source is comprised of a laser diode and a collimator.

7. The optical system as claimed in claim 5, wherein said light source is comprised of a light emitting diode and a collimator.

8. The optical system as claimed in claim 5, wherein said light source and said standing cylindrical lens are adapted to emit a line-shaped light beam onto the barcode of the product in a slanting angle; said line-shaped light beam shows a light intensity distribution curve that is a deformation curve that is asymmetric between the left side and the right side.

9. The optical system as claimed in claim 5, wherein said reflector means is comprised of at least one reflecting mirror.

10. An optical system used in a barcode scanner for reading a barcode of a product, the optical system comprising:
a light source adapted to emit a dot-shaped light beam onto the barcode of the product;
a standing cylindrical lens adapted to expand the dot-shaped light beam produced by said light source as a line-shaped light beam onto the barcode of the product in a slanting angle;
a focusing lens adapted to focus an image reflected by the barcode of the product;
a linear sensor array adapted to receive the image focused by said focusing lens; and
shaking means adapted to cause reciprocation of the light beam in direction perpendicular to the light path of said light source.

11. The optical system as claimed in claim 10, wherein said light source is comprised of a laser diode and a collimator.

12. The optical system as claimed in claim 10, wherein said light source and said standing cylindrical lens are adapted to emit a line-shaped light beam onto the barcode of the product in a slanting angle; said line-shaped light beam shows a light intensity distribution curve that is a deformation curve that is asymmetric between the left side and the right side.

13. The optical system as claimed in claim 10, further comprising at least one reflector means mounted in the focal distance of said focusing lens and adapted to reflect the image focused by said focusing lens onto said linear sensor array, the light path of said reflector means being overlapped with the light path of said focusing lens to form a light path overlap region.

14. The optical system as claimed in claim 10, wherein the shaking means to cause reciprocation of the light beam in direction perpendicular to the light path of said light source is adapted to reciprocate said standing cylindrical lens in direction perpendicular to the light path of said light source.

15. The optical system as claimed in claim 10, wherein the shaking means to cause reciprocation of the light beam in direction perpendicular to the light path of said light source is to employ a voltage to said standing cylindrical lens to cause a change of crystal structure of said standing cylindrical lens, thereby resulting in reciprocation of the light beam expanded by said standing cylindrical lens in direction perpendicular to the light path of said light source.

16. The optical system as claimed in claim 10, wherein the shaking means to cause reciprocation of the light beam in direction perpendicular to the light path of said light source is to reciprocate a proximity side of said light source relative to said standing cylindrical lens in direction perpendicular to the light path of said light source.

17. The optical system as claimed in claim 10, wherein the shaking means to cause reciprocation of the light beam in direction perpendicular to the light path of said light source is to reciprocate a distal side of said light source relative to said standing cylindrical lens in direction perpendicular to the light path of said light source.
